(19) United States
(12) Patent Application Publication
(10) Pub. No.: US 2006/0195704 A1
(43) Pub. Date: Aug. 31, 2006

(54) Disk array encryption element

(75) Inventors: Robert A. Cochran, Sacramento, CA (US); Jay J. Schultz, Sacramento, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX (US)

(21) Appl. No.: 11/045,230

(22) Filed: Jan. 27, 2005

(51) Int. Cl. G06F 11/00; G06F 12/14; G06F 1/26; H04L 9/32; G08B 13/00; G06F 11/30; G08B 21/00; G08B 29/00

(52) U.S. Cl. 713/193; 726/34

(57) ABSTRACT

A method for securing data stored in a disk array storage system comprises communicating data between at least one host system and a disk array and selectively encrypting and decrypting the communicated data within the disk array on a per-logical unit/per-disk basis.

### BACKGROUND

Storage system and disk array users are highly sensitive to data security concerns. For example, confidential data on replacement disk drives may be carried from secured premises by outside service personnel. In one incident, an old disk drive from an Automated Teller Machine (ATM) was purchased on a resale market and found to contain thousands of account numbers.

Although concerns regarding security of disk drive data have been known for many years, better data security techniques are sought. Recent legislation imposes financial penalties on companies that allow private customer data to leave the company's control without authorization. For example, California law SB 1386 requires an agency, person, or business that conducts business in California and owns or licenses computerized “personal information” to disclose any breach of security to any resident whose unencrypted data is believed to have been disclosed.

For most business entities, strong encryption such as 256-bit Advanced Encryption Standard (AES) may solve the problem of disk drives that leave the control of the business as well as enabling security of remotely-replicated data. However, encryption has not solved all difficulties.

Two data security approaches are conventionally used. In a first approach, a dedicated encryption appliance is placed between an application host and a disk array. In a second approach, a host system includes a host operating system driver stack with an encryption capability. The approaches have limitations and supply data security for only one host or at most a few hosts in an enterprise class disk array that may possibly include hundreds or more hosts.

### SUMMARY

A method for securing data stored in a disk array storage system comprises communicating data between at least one host system and a disk array and selectively encrypting and decrypting the communicated data within the disk array on a per-logical unit/per-disk basis.

### BRIEF DESCRIPTION OF THE DRAWINGS

Embodiments of the invention relating to both structure and method of operation, may best be understood by referring to the following description and accompanying drawings:

FIGS. 1A and 1B are schematic block diagrams depicting an embodiment of a storage apparatus adapted to secure data in a storage system;

FIG. 2 is a schematic block diagram illustrating another embodiment of a storage apparatus including a disk array with data security functionality;

FIG. 3 is a schematic block diagram showing an embodiment of a storage apparatus including data security functionality;

FIGS. 4A through 4E are schematic flow charts illustrating embodiments of a technique for handling secure and non-secure data using an encryption/decryption processor under various circumstances and/or conditions; and

FIGS. 5A, 5B, and 5C are flow charts depicting embodiments of techniques for handling remotely-replicated data.

### DETAILED DESCRIPTION

An illustrative storage system and operating method solves data security concerns by including an encryption architectural element within a disk array. The encryption element may be interposed between a channel host adapter and a duplexed write cache. The encryption element can optionally and selectively perform encryption and/or decryption either directly, using resources internal to the array, or via an optional external encryption/decryption hardware assistance blade or module.

Inclusion of the encryption element within a disk array enables centralized, transparent, and flexible data security in a manner that protects not only data from exposure via removal from the secured premises during repair and replacement of disk drives, but also data exposed to interception on communication to a remote replication or storage site. All hosts connected to a disk array with internal security benefit from the security services, not merely a few hosts attached to a security device exterior to a disk array. Inclusion of the encryption element within a disk array also facilitates efficient data security capabilities for a system administrator or user by avoiding or eliminating difficulties associated with connecting an external encryption device into a system. The disk array with internal encryption element isolates the system administrator or user from the intricacies and responsibility associated with encryption, decryption, key management, and secure key transfer. System administrators and users often have little expertise in data encryption aspects including technical knowledge of encryption and decryption, key management, key archiving, and secure key transfer, as well as a lack of familiarity with trusted manufacturers and equipment and service providers. Accordingly, system administrators and users may be reluctant to deal with selection, installation, and maintenance and service of external devices and components that can be connected into a network. A disk array with internal data security capability supplies secure data handling in a transparent and centralized manner.

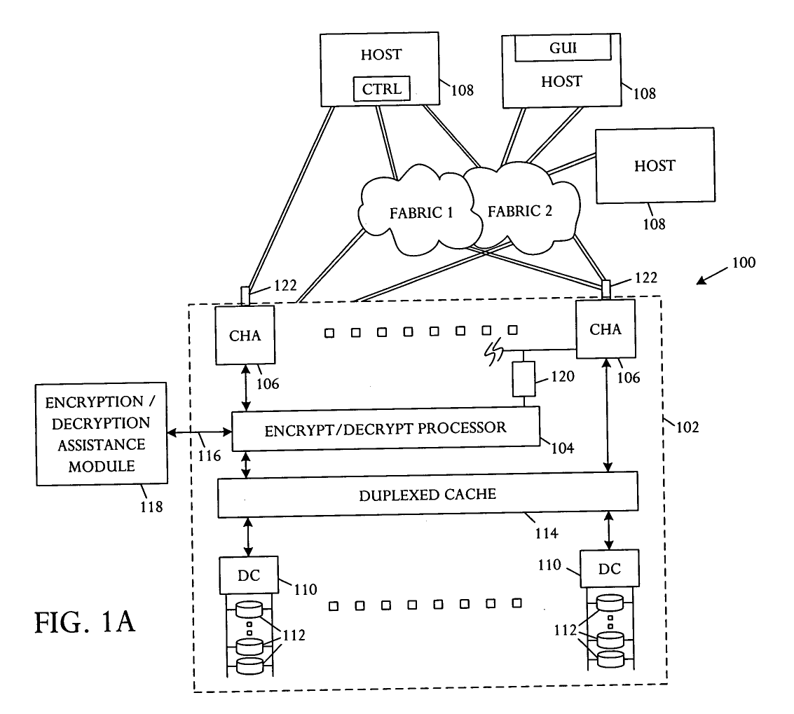

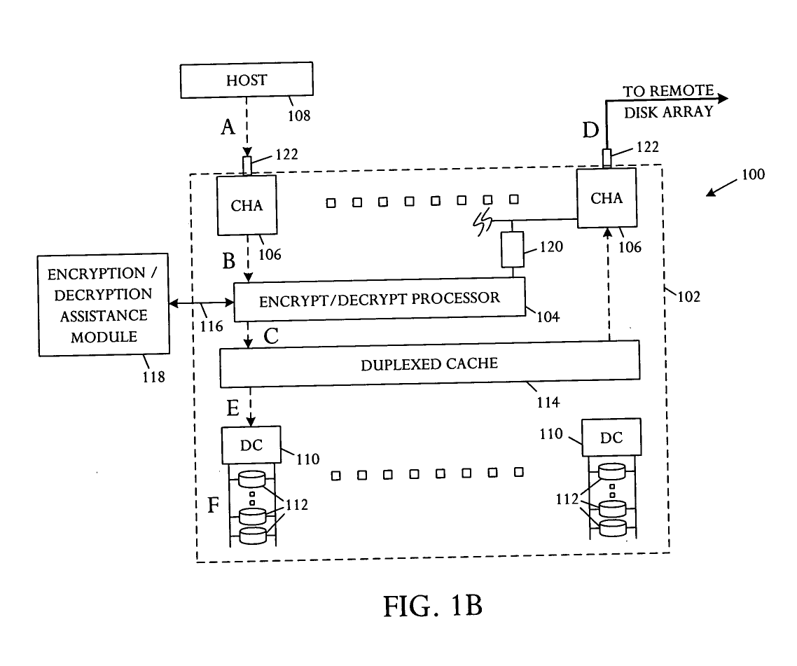

Referring to FIGS. 1A and 1B, schematic block diagrams depict an embodiment of a storage apparatus 100 adapted to secure data in a storage system. The storage apparatus 100 comprises a disk array 102 and an encryption/decryption processor 104 interior to the disk array and adapted to perform data encryption and decryption operations on a per-logical unit basis.

The illustrative embodiment shows a disk array 102 with a plurality of channel host adapters 106 which are adapted to communicate data among multiple host systems 108. A disk array 102 commonly has many channel host adapters 106. An example implementation may have 1 to 32 channel host adapters 106, each supplying multiple, for example 1-32, external ports for connection to devices such as application hosts. Other examples may have more channel host adapters and/or more external ports. The disk array 102 further includes one or more disk controllers 110 and an array of storage disks 112 with connections distributed among the disk controllers 110. A disk array 102 also commonly has many disk controllers 110. An example implementation may have 1-16 disk controllers 110, each of which controls multiple disks, for example up to 64 disks such as Fibre Channel disks. Other disk array embodiments may have more than sixteen disk controllers, possibly controlling a larger number of disks.

A duplexed cache 114 is coupled between the plurality of channel host adapters 106 and the disk controllers 110. The encryption/decryption processor 104 is coupled between the channel host adapters 106 and the duplexed cache 114.

The depicted disk array 102 further includes an interface 116 that is adapted to optionally interconnect the encryption/decryption processor 104 to an encryption/decryption assistance module 118 which may be either inside or outside the disk array 102.

In some embodiments, the disk array 102 may include logic 120 to generate a unique per-array encryption key for usage in encryption operations.

The encryption/decryption processor 104 operates as an accessory architectural element that can be added to a disk array 102, even a conventional disk array arrangement, to selectively enable data encryption and decryption services on a per-logical unit and/or per-disk basis. Accordingly, a system administrator or user can optionally enable or disable encryption, on the per-logical unit/per-disk basis. Any protected disk drive maintains security, even in cases that a drive is removed from the secured environment for repair.

FIG. 1B illustrates an example of a typical application host write progression. A host 108 writes (action A) data to the disk array 102, designating the target logical unit, track and sector. In some examples, the host write data may be written to an external port buffer 122 of the disk array 102. A channel host adapter 106 connected to the external port buffer 122 transfers (B) the write data from the external port buffer 122 to the encryption/decryption processor 104 internal to the disk array 102.

If the target disk of the designated logical unit is included on a list of encrypted target disks so that data encryption is selected for particular write data, the encryption/decryption processor 104 encrypts the data and writes (C) the encrypted data to the duplexed cache 114. A channel host adapter 106, either the same adapter that received the write request or a different adapter of the plurality of channel host adapters 106 as shown in the example, transfers (D) the synchronous replication of encrypted data from the local cache 114 to a cache in a remote disk array. In combination with the transfer (D), the channel host adapter 106 which received the write data in action (A) sends a signal to the host 108 indicating completion of the write operation.

Logic in the disk array 102 maps (E) the requested logical unit to the disk controller 110 designated by data write command and communicates target data location and destination to the disk controller 110. Logic also maintains a list of the logical units and disks which store encrypted data. The disk controller 110 writes (F) the data to the designated storage disk or disks 112.

For data that is encrypted, the data is stored locally, in the original disk array 102 that receives the write data from the host 108, and the encrypted data is replicated in the encrypted form, regardless of which of the potentially hundreds or more hosts originated the data. Accordingly, encrypted data involved in remote replication or storage maintains protection. For example, the illustrative storage apparatus 100 may be used with HP StorageWorks™ Continuous Access XP Extension technology to supply secure high-availability and disaster recovery with host-independent real-time remote data mirroring between XP disk arrays. The illustrative storage apparatus 100 may further be used with HP StorageWorks™ External Storage XP technology to enable storage of disk array datasets on external storage subsystems. HP StorageWorks™, Continuous Access, External Storage, and associated XP extension technology are made available by Hewlett-Packard Company of Houston, Tex.

When data enters a disk array 102 as remotely replicated and in previously encrypted form, metadata associated with the data signals to the encryption/decryption processor that the data is previously encrypted, enabling the data to pass through the encryption/decryption processor, bypassing the encryption operation. The metadata may also include a secured version of the data decryption key for the particular data, which is saved in a shared memory table on the receiving storage array.

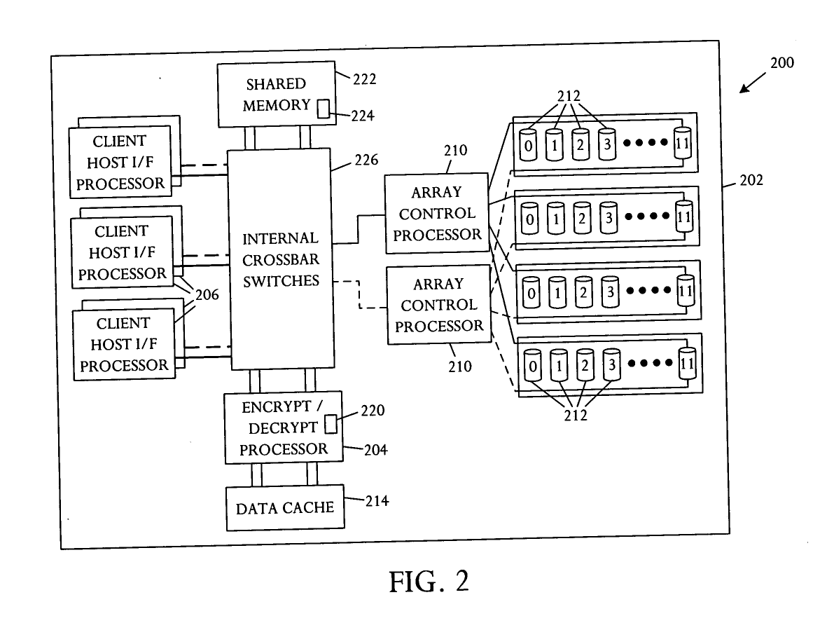

Referring to FIG. 2, a schematic block diagram depicts another embodiment of a storage apparatus 200 including a disk array 202 with data security functionality. The disk array 202 comprises an array of storage disks 212 coupled through disk controllers, for example in a configuration using array control processors 210, and through internal crossbar switches 226 to an encryption/decryption processor 204. The storage disks 212 are virtually accessed as logical units. A logic 220, for example arranged within the encryption/decryption processor 204, may be coupled to a shared memory 222 including memory which may be used for a memory table 224 shared among the array of storage disks 212 and the logical units. The memory table 224 is adapted to track storage disks and logical units which are predetermined to store encrypted data.

The logic 220 may be configured to map a requested logical unit to one or more of the storage disks 212. The logic 220 may designate the data location and destination, and maintain a list of logical units and disks that store encrypted data in the memory table 224.

An internal crossbar switch enables fast, efficient switching with direct point-to-point connections. The shared memory 222 stores command and control data, enabling the entire data cache 214 to be allocated for quick access to user data. The shared memory 222 is independent of the cache 214 and is used to store tables, side files, and other overhead information, thus freeing the cache 214 for user data. The shared memory 222 may also be used to store system configuration mapping of system components, logical unit (LUN) maps, cache pointers, hit rates, and RAID levels, as well as encryption information such as encryption enabling and key storage. Client Host Interface Processors (CHIP) 206 may be used as channel host adapters and arranged in pairs supporting connections from host servers to the disk array 202. In an illustrative embodiment, the Client Host Interface Processor (CHIP) pairs may be configured as 4-port and 8-port Fibre Channel (FC) adapter pairs, or as 4-port and 8-port Extended serial interface (ExSA), ESCON (Enterprise System CONnection)-compatible adapter pairs.

Array Control Processors (ACP) 210 function as disk controllers for the array of disks 212. The Array Control Processors 210 in the illustrative embodiment may also be configured in pairs for redundancy. ACP functions include managing read and write operations to the disks 212, read miss staging, and write destaging from the cache 214. The Array Control Processors 210 may also perform media protection, for example by techniques such as dynamic spares, mirrored storage in RAID 0/1 (Redundant Array of Independent Disks), dynamic data rebuild, and hardware RAID 5 parity generation.

The illustrative data cache 214 is a dynamic duplex cache functioning as an area of cache set aside for “write” data. All data written to the cache 214 is written to the dynamic duplex cache 214 and is duplicated across power boundaries for a system that includes a fully redundant battery. The write cache percentage may be modified manually or dynamically.

A fast write occurs when the cache 214 is not full and does not need to be destaged to the disk 212 before the write can occur. The CHIP 206 may initiate a search on the cache directory in shared memory 222 to determine whether an old copy of the data to be written remains in the cache 214 and whether cache space remains available. Data is transferred from the host to the cache 214 and duplexed to first and second sub-caches within the cache 214 on different sides of a power boundary. A cache directory in shared memory 222 is modified to reflect the most recently used data. The host is notified of I/O (input/output) completion. Data in the cache 214 is destaged to a disk 212 in a background operation. Data is written to both cache areas in the duplex cache 214 to enable data restoration if a cache error occurs before the data is written to physical disk 212 when only a single copy of the data is in the cache. After successful destaging of the data to the disk, the cache data is switched into the read area and only one copy is maintained in the cache 214.

A deferred write occurs if the duplex write cache is at a write limit and cannot accept new data before destaging a cache block to a disk 212. The CHIP 206 initiates a search on the cache directory in shared memory 222 and identifies that the cache 214 is full. The least recently used data is identified and destaged to disk 212. After the least recently used data is destaged, the data is transferred from the host to the cache 214 and duplexed to both cache subdivisions. The cache directory is updated to reflect the most recently used data, and the host is notified of I/O completion. Data in the cache 214 is destaged to the disk 212 in the background.

The disk array 202 maintains the shared memory table 224 to track logical units and/or disks which are designated to hold encrypted data and accordingly to manage encryption and decryption operations. An entry in the shared memory table 224 is made at the time of disk formatting and applies to all logical units using the disk. If local array resources are sufficient, or if local response times are not critical, the encryption/decryption processor 204 performs data encryption and/or decryption operations without assistance. Otherwise, the encryption/decryption processor 204 may operate in combination with an optional encryption/decryption hardware assistance blade such as the module 118 shown in FIGS. 1A and 1B. One example of a suitable encryption/decryption hardware assistance module 118 is a Datafort FC-Series Storage Security Appliance, made available by Decru, Inc. of Redwood City, Calif. A suitable encryption/decryption hardware assistance module may be adapted to plug into the disk array backplane and use a fast, low overhead communications protocol on the link 116 to the encryption/decryption processor.

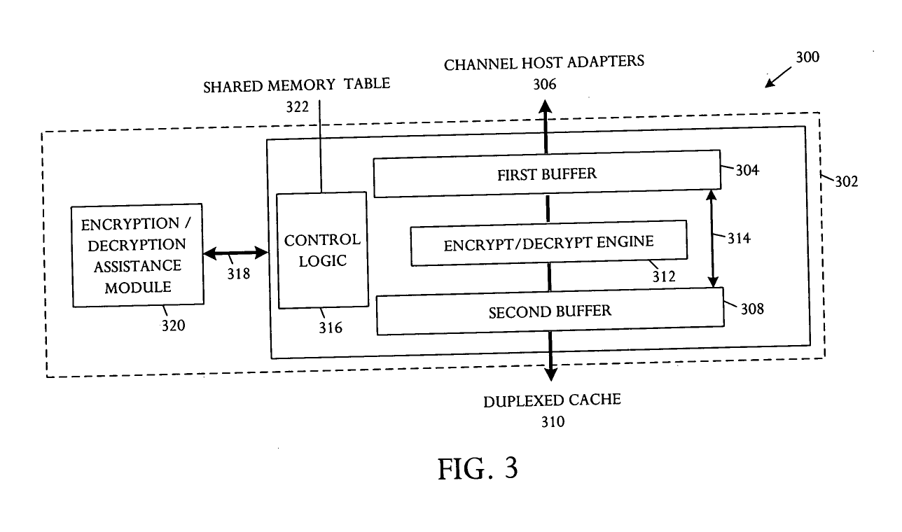

Referring to FIG. 3, a schematic block diagram shows an embodiment of a storage apparatus 300 including data security functionality. The storage apparatus 300 comprises an encryption/decryption processor 302 configured for usage interior to a disk array. The encryption/decryption processor 302 is adapted to perform data encryption and decryption operations on a per-logical unit basis.

In the exemplified storage system 300, the encryption/decryption processor 302 has a first buffer 304 configured to couple to a plurality of channel host adapters 306. The first buffer 304 holds data passing to and from multiple host systems. The encryption/decryption processor 302 has a second buffer 308 configured to couple to a duplexed cache 310. The second buffer 308 holds data passing to and from the duplexed cache 310. An encryption/decryption engine 312 is coupled between the first buffer 304 and the second buffer 308 and may be operated to encrypt and decrypt selected data.

The encryption/decryption processor 302 may have a pass-through link 314 coupled between the first buffer 304 and the second buffer 308 that passes data between the buffers 304, 308, bypassing the encryption/decryption engine 312 for usage with logical units and disks that store unencrypted data and in conditions when data encryption and decryption is inappropriate or unwarranted. Control logic 316 controls operations of the encryption/decryption engine 312 and the pass-through link 314. For data that is to be encrypted or decrypted, the control logic 316 activates the encryption/decryption engine 312. For logical units or disks storing non-encrypted data or for conditions in which encryption or decryption is inappropriate, the control logic 316 disables the encryption/decryption engine 312 and activates the pass-through link 314.

The control logic 316 is shown which communicates with a memory table 322 configured to hold information shared among an array of storage disks and logical units associated with the storage disk array. The memory table 322 tracks storage disks and logical units that store encrypted data according to a predetermined designation. In some embodiments, the control logic 316 may be adapted to generate a unique per-array encryption key for usage in encryption.

The illustrative encryption/decryption processor 302 has an interface 318 coupled to the control logic 316 that is adapted to optionally and selectively interconnect the encryption/decryption processor 302 with an encryption/decryption assistance module 320.

During write operations, the encryption/decryption engine 312 optionally performs a suitable data encryption function on the data received from the first buffer 304 and transfers the result in the second buffer 308 for transfer to the duplexed cache 310. Examples of suitable encryption functions include Data Encryption Standard (DES), triple-DES, 256-bit Advanced Encryption Standard (AES), and the like.

During read operations, the encryption/decryption engine 312 receives data from the cache 310 via the second buffer 308 and decrypts the data, passing the decrypted data to the first buffer 304 for access by the channel host adapters 306. If the optional encryption/decryption assistance module 320 is installed and activated, the encryption/decryption engine 312 may use the encryption/decryption assistance module 320 to conserve disk array resources. The pass-through link 314 is used if encryption and/or decryption services are not warranted, for example when encryption and/or decryption services are not enabled for a particular logical unit and/or disk. Encryption and/or decryption services are also not used when previously encrypted data originating from a remote replication link is destaged or stored.

The disks to be associated with encryption are designated during formatting. All logical units on a particular disk drive within a disk array have encryption either enabled or disabled. For example, the default condition may designate encryption status as disabled with encryption enabled only at the time of disk formatting. The encryption status for the disk is noted and stored in the shared memory table 322. When the encryption/decryption engine 312 is activated, the shared memory table 322 is checked by control logic 316. If the table entry for the associated disk drive is set to ‘disabled’ or ‘off’, or if the data is arriving in a pre-encrypted condition over a remote replication link, then the encryption/decryption engine 312 and the pass-through link 314 are controlled to pass the data through without alteration. Otherwise, the encryption/decryption engine 312 performs the encryption operation, for example encrypting for writes and decrypting for reads from the perspective of the application host.

The control logic 316 also ensures that a logical unit is consistent in usage of encryption. For example, if a logical unit spans multiple disks, encryption is enabled or disabled consistently across all the logical unit-associated disks.

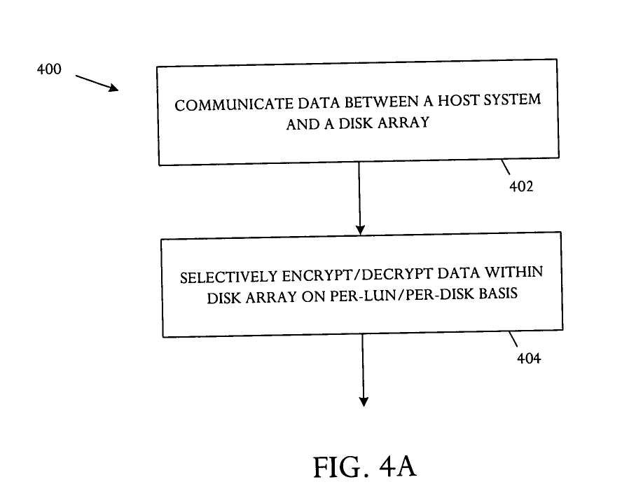

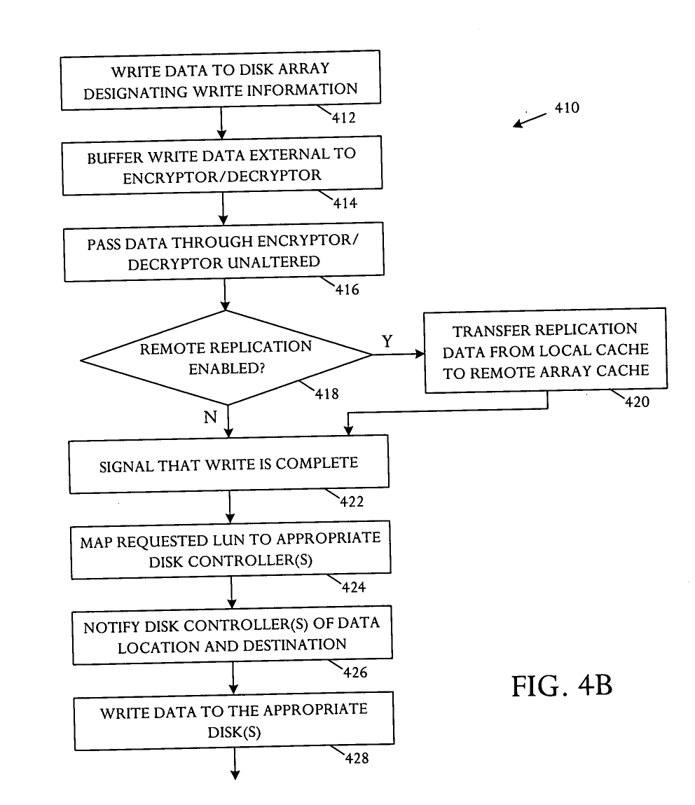

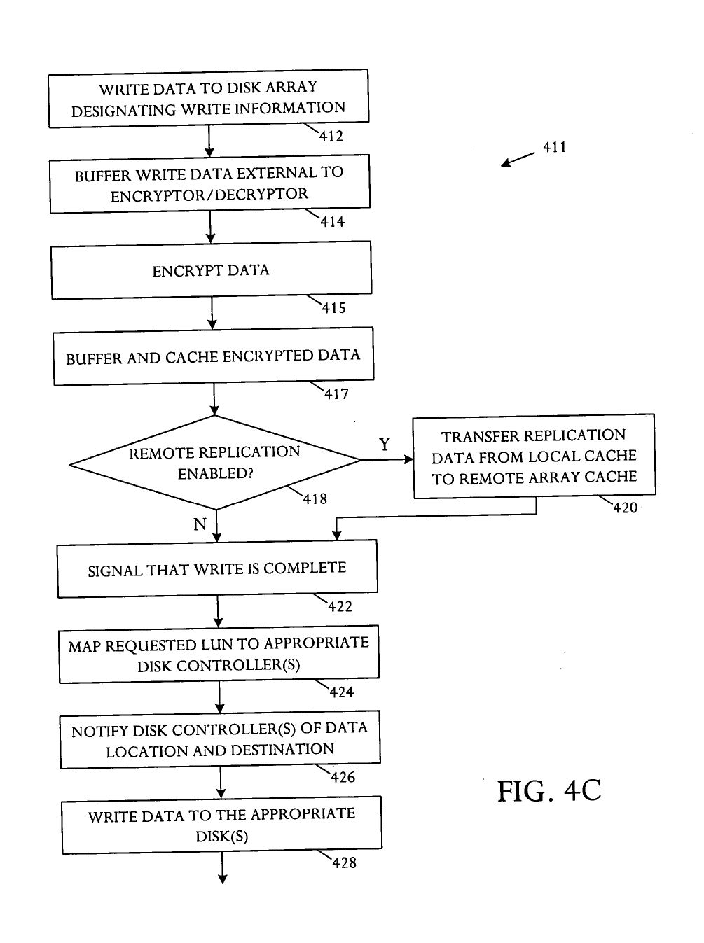

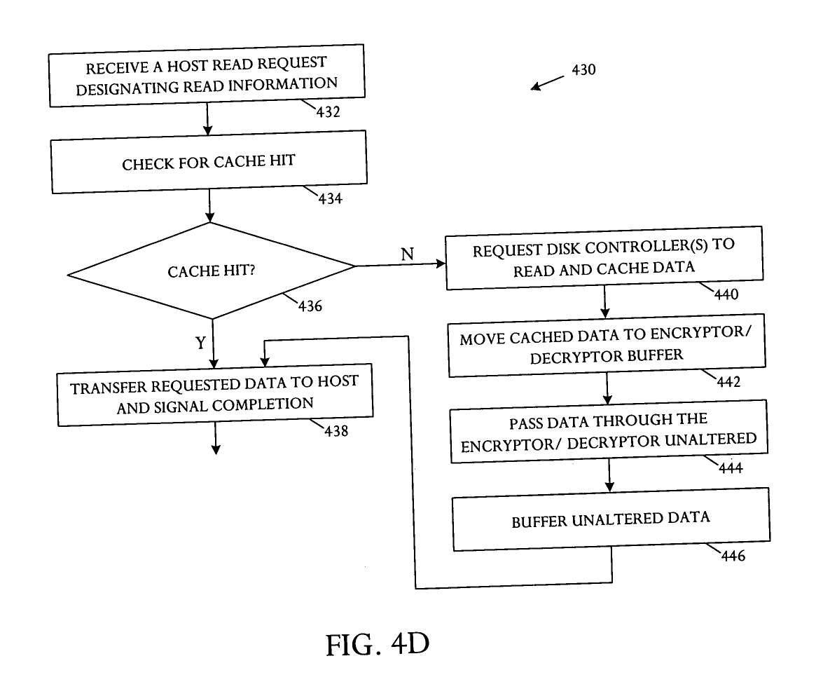

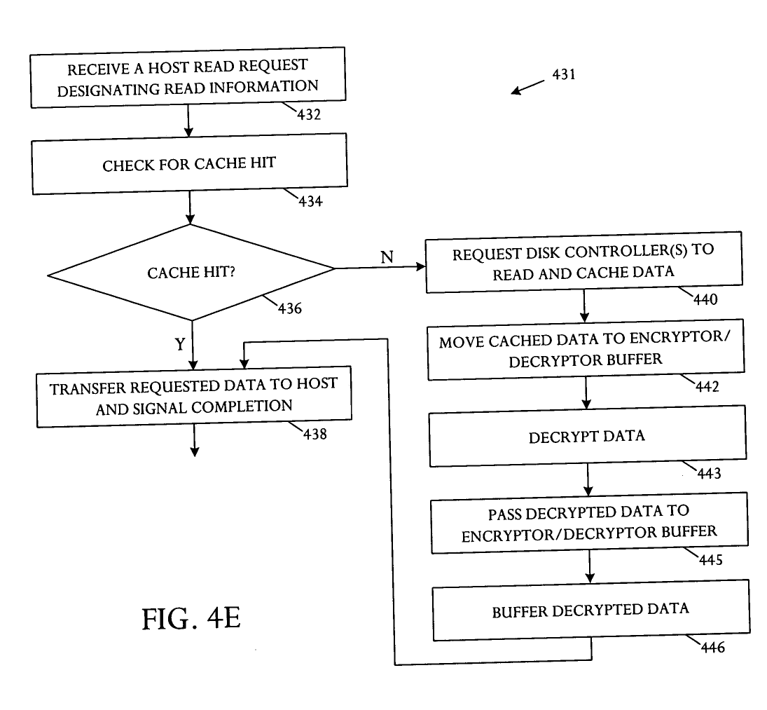

FIGS. 4A through 4E are schematic flow charts illustrating embodiments of a technique for handling secure and non-secure data using the encryption/decryption processor under various circumstances and/or conditions. Referring to FIG. 4A, a flow chart depicts an embodiment of a method 400 for securing data stored in a disk array storage system. The method 400 comprises communicating 402 data between at least one host system and a disk array and selectively encrypting and decrypting 404 the communicated data within the disk array on a per-logical unit/per-disk basis.

In a host write operation, the disk array receives a host write from a host at the disk array that designates logical unit, track, sector, and length information. Within the disk array, the data may be selectively encrypted, based on predetermined per-logical unit and/or per-disk selection, for the host write operation. The selectively encrypted or non-encrypted write data is cached and may be transferred to a remote array cache. The disk array returns a write-complete message to the host, maps the requested logical unit to one or more designated disk controllers, and informs the target designated disk controllers of write data location and destination. Data is written to the designated disks.

FIG. 4B illustrates an example of a host write embodiment with encryption disabled 410. A host writes 412 data to an external port buffer of an array and designates write information including, for example, logical unit, track, sector, and data length. A channel host adapter transfers 414 the write data from the external port buffer to a first buffer internal to an encryption/decryption processor. An encryption engine passes through 416 the data to a second buffer unaltered and then to a duplexed write cache. If synchronous remote replication is enabled 418, a channel host adapter, either the adapter receiving the host write or another adapter in the same disk array, transfers 420 the synchronous replication data from the local duplexed cache to a cache in a remote array. Metadata associated with the write data specifies that data encryption is neither warranted nor appropriate since encryption is disabled. Regardless of whether synchronous remote replication is enabled, the channel host adapter signals 422 to the host that the write operation is complete. Logic, for example disk array firmware in some embodiments, maps 424 the requested logical unit to the correct disk controller or controllers. The logic also notifies 426 the disk controller or controllers of the data location and destination. The disk controller or controllers writes 428 the data to the correct disk or disks.

FIG. 4C illustrates an example of a host write embodiment with encryption enabled 411. The host writes 412 data to the array external port buffer and designates write information. The channel host adapter transfers 414 the write data from the external port buffer to the encryption/decryption processor first buffer. The encryption engine encrypts 415 the data, either locally to the encryption/decryption processor or in an external encryption/decryption assistance blade or module, and writes 417 the encrypted data to the second buffer and then to the duplexed write cache. If synchronous remote replication is enabled 418, the channel host adapter, either the adapter receiving the host write or another adapter in the same disk array, transfers 420 the synchronous replication encrypted data from the local duplexed cache to the remote array cache. Metadata associated with the write data specifies a key to be used for decryption during subsequent read operations. Regardless of whether synchronous remote replication is enabled, the channel host adapter signals 422 to the host that the write operation is complete. Logic maps 424 the requested logical unit to the correct disk controller or controllers and notifies 426 the disk controller or controllers of the data location and destination. The disk controller or controllers writes 428 the encrypted data to the correct disk or disks.

In a host read operation, the disk array receives a read request from a host that designates logical unit, track, sector, and length information and checks for a cache hit indicative that the read request data is cached. If cache hit status is not affirmative, the disk array reads data from disks designated by the read request. Read data that is previously encrypted on a per-logical unit and/or per-disk basis is decrypted within the disk array. Previously non-encrypted data is passed through without decrypting. The requested read data is transferred to the host in combination with a read-complete indication.

FIG. 4D illustrates an example of a host read embodiment without decryption 430. A host requests 432 a read from an external port buffer of a disk array and designates read information, for example including logical unit, track, sector, and length. Logic, for example firmware in the disk array, checks 434 the cache for a cache hit indicating that the data designated by the host read is present in the cache. For a cache hit 436, the channel host adapter transfers 438 the requested data to the host, for example by way of second buffer 308, pass-through link 314, and first buffer 304 as shown in FIG. 3, and signals completion of the read. In absence of a cache hit, logic requests 440 an appropriate disk controller or controllers to read the data from the appropriate disk or disks and place the read data into the cache. Logic moves 442 the read data from the cache to a second buffer of the encryption/decryption processor. The encryption/decryption processor passes through 444 the data unaltered from the form read from the disk or disks to a first buffer, and places 446 the read data into a buffer in the channel host adapter. The channel host adapter transfers 438 the requested data to the host and signals read completion.

FIG. 4E illustrates an example of a host read embodiment with decryption 431. The host requests 432 a read from the disk array external port buffer and designates the read information. Logic checks 434 the cache for a cache hit. For a cache hit 436, the channel host adapter transfers 438 the requested data to the host, for example by way of second buffer 308, pass-through link 314, and first buffer 304 shown in FIG. 3, and signals completion of the read. In absence of a cache hit, logic requests 440 the appropriate disk controller or controllers to read data from the appropriate disk or disks and place the read data into the cache. Logic moves 442 the read data from the cache to the encryption/decryption processor second buffer. The encryption/decryption processor decrypts 443 the data either locally or in the encryption/decryption assistance module external to the disk array and places 445 the decrypted data into the first buffer, and places 446 the read data into the channel host adapter buffer. The channel host adapter transfers 438 the requested data to the host and signals read completion.

In some embodiments, a storage system may implement functionality of key management between disk arrays. Key management eliminates or alleviates user responsibility for key creation. The disk array may generate a unique per-array key by defining a seed value for usage in a random number generator. In one example, the disk array may use the current date and time designating the moment at which the license key is enabled as the seed value of a suitable bit size. A common bit size is 256 bits although any other suitable bit size may be implemented. In another example, the disk array may receive a value over a network, such as the Internet, by making a request for a key or a secure key generator value.

In some examples, the disk array engaging in remote replication use identical encryption/decryption keys. In other, possibly more flexible examples, the disk array engaging in remote replication may use a shared memory table entry for a logical unit that is remotely written from another disk array and also contains the appropriate and correct key for the logical unit's data. Remote replication metadata can transfer the key to the remote array via standard secure key transfer techniques such as, for example, a 1024-bit RSA (Rivest, Shamir, and Adelman) algorithm for secure encryption key exchange.

A disk array may also perform de-staging of remotely-replicated encrypted or non-encrypted data. The disk array receives remotely-replicated data, parses the remotely-replicated data to ensure completeness and ordering, and checks the remotely-replicated metadata according to a shared memory table that is used to track encrypted data stored in identified storage disks and logical units. The disk array passes the remotely-replicated data without encryption, either on the basis that the data was previously encrypted or that the associated logical unit and/or disk stores non-encrypted data. The disk array maps a logical unit and writes the remotely-replicated data to storage.

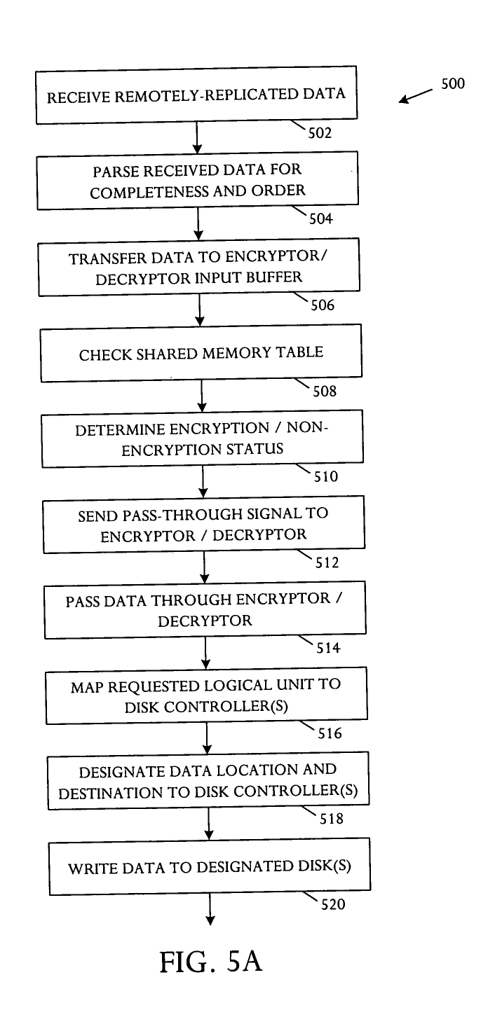

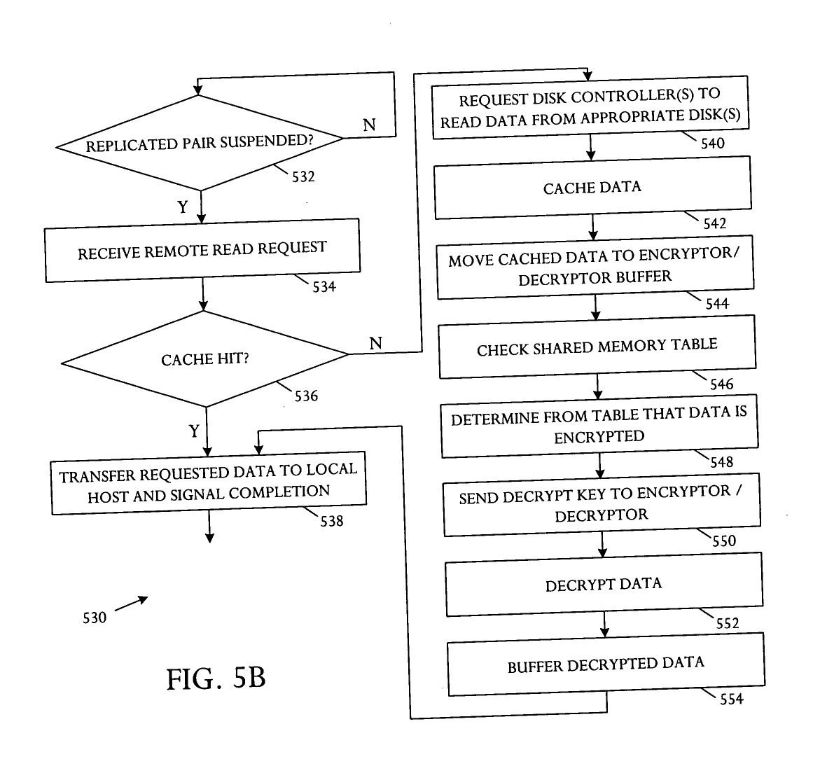

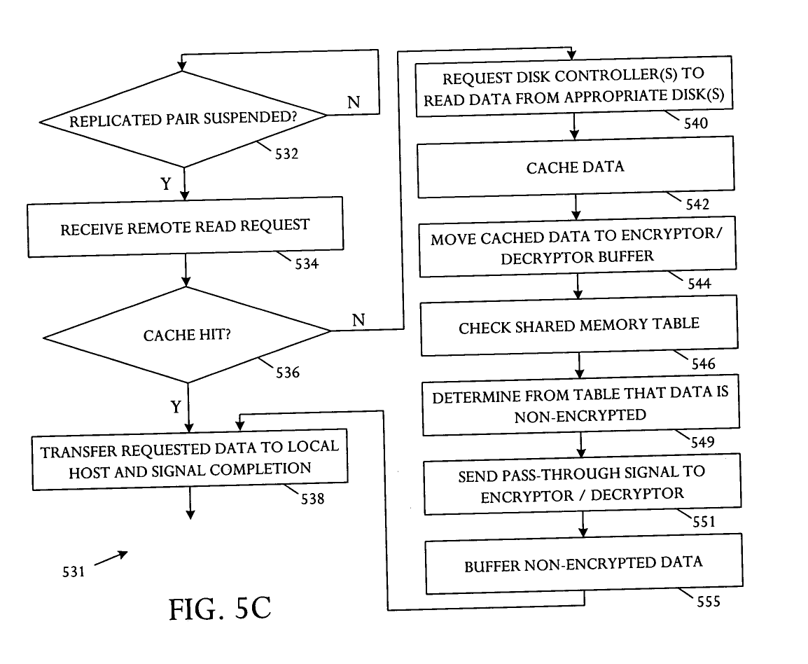

Referring to FIGS. 5A, 5B, and 5C, flow charts depict embodiments of techniques for handling remotely-replicated data. FIG. 5A illustrates an embodiment of a technique for de-staging remotely-replicated, encrypted or non-encrypted data 500. The disk array receives 502 remotely-replicated data at a channel host adapter buffer. The channel host adapter and disk array logic, in some implementations array firmware, parse 504 the data and metadata to ensure that the data is complete, in the correct order, and data encryption has been employed. The parsed data is transferred 506 to a first buffer in an encryption/decryption processor. The array logic checks 508 replication metadata and a shared memory table, determines 510 from accessing the table that the data is replicated data that is either already encrypted by operation of the original disk array or non-encrypted by designation, and sends 512 a pass-through signal to the encryption/decryption processor. The pass-through signal causes the encryption/decryption processor to pass 514 the data unaltered from a first to a second buffer in the encryption/decryption processor. Disk array logic maps 516 the requested logical unit to the appropriate and correct disk controller or controllers, and signals 518 to the disk controller or controllers the designated data location and destination. The disk controller or controllers writes 520 the data to the designated disk drive or drives.

A disk array may also perform remotely-replicated read operations of encrypted or non-encrypted data. During suspension of a replicated pair, the disk array receives a read request from a local host. The read request designates target information such as logical unit, track, sector, and length information. For a read request that is a cache hit, requested non-encrypted data is transferred directly from the cache to the local host by way of second buffer 308, pass-through link 314, and first buffer 304 shown in FIG. 3, in combination with a read-complete signal. For a read request that is a cache hit, requested encrypted data is transferred directly from the cache to the local host by way of second buffer 308, pass-through link 314, and first buffer 304. For a cache miss, the disk array retrieves requested data from storage by reading data from storage according to the designated target information, caching the data, and checking a shared memory table that stores information indicative of whether the requested data is remotely-replicated encrypted data or non-encrypted data. Encrypted data is decrypted according to a decrypt key in the shared memory table. Non-encrypted data is passed-through without decryption. The requested data is transferred to the local host in combination with a read-complete signal.

FIG. 5B illustrates an embodiment of a technique for reading remotely-replicated, encrypted data 530. While a replicated pair is suspended 532, a local host makes a remote read request 534 from an external port buffer of the disk array, designating read information such as logical unit, track, sector, and length. In the event of a cache hit 536, a channel host adapter transfers 538 the requested data to the local host by way of second buffer 308, pass-through link 314, and first buffer 304 shown in FIG. 3, and signals completion of the read. For a cache miss, disk array logic requests 540 the correct disk controller or controllers to read the data from the appropriate disk or disks and caches 542 the read data. Logic moves 544 the data from the cache to a second buffer of the encryption/decryption processor. Logic checks 546 the shared memory table, determines 548 from the table that the data is remotely-replicated, encrypted data, and sends 550 the appropriate decrypt key which is accessed from the table to the encryption/decryption engine. The encryption/decryption engine decrypts 552 the data and passes 554 the decrypted data to a first buffer in the encryption/decryption processor and then to a buffer in the channel host adapter. The channel host adapter transfers 538 the requested data to the local host and signals that the read is complete.

FIG. 5C illustrates an embodiment of a technique for reading remotely-replicated, non-encrypted data 531. While a replicated pair is suspended 532, a local host makes a remote read request 534 from an external port buffer of the disk array, designating read information such as logical unit, track, sector, and length. In the event of a cache hit 536, a channel host adapter transfers 538 the requested data to the local host by way of second buffer 308, pass-through link 314, and first buffer 304 shown in FIG. 3, and signals completion of the read. For a cache miss, disk array logic requests 540 the correct disk controller or controllers to read the data from the appropriate disk or disks and caches 542 the read data. Logic moves 544 the data from the cache to a second buffer of the encryption/decryption processor. Logic checks 546 the shared memory table, determines 549 from the table that the data is remotely-replicated, non-encrypted data, and sends 551 a pass-through signal to the encryption/decryption engine. The encryption/decryption engine passes 555 the non-encrypted data to a first buffer in the encryption/decryption processor and then to a buffer in the channel host adapter. The channel host adapter transfers 538 the requested data to the local host and signals that the read is complete.

The various functions, processes, methods, and operations performed or executed by the system can be implemented as programs that are executable on various types of processors, controllers, central processing units, microprocessors, digital signal processors, state machines, programmable logic arrays, and the like. The programs can be stored on any computer-readable medium for use by or in connection with any computer-related system or method. A computer-readable medium is an electronic, magnetic, optical, or other physical device or means that can contain or store a computer program for use by or in connection with a computer-related system, method, process, or procedure. Programs can be embodied in a computer-readable medium for use by or in connection with an instruction execution system, device, component, element, or apparatus, such as a system based on a computer or processor, or other system that can fetch instructions from an instruction memory or storage of any appropriate type. A computer-readable medium can be any structure, device, component, product, or other means that can store, communicate, propagate, or transport the program for use by or in connection with the instruction execution system, apparatus, or device.

The illustrative block diagrams and flow charts depict process steps or blocks that may represent modules, segments, or portions of code that include one or more executable instructions for implementing specific logical functions or steps in the process. Although the particular examples illustrate specific process steps or acts, many alternative implementations are possible and commonly made by simple design choice. Acts and steps may be executed in different order from the specific description herein, based on considerations of function, purpose, conformance to standard, legacy structure, and the like.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims. For example, the disclosed disk arrays, encryption/decryption processors, and encryption/decryption engines may have any suitable configuration and may include any suitable number of components and devices. Additional data buffers may be included in the disk array or particular buffers may be eliminated in other embodiments. Any type of encryption and decryption techniques and algorithms may be used. The flow charts illustrate data handling examples and may be further extended to other read and write functions, or may be modified in performance of similar actions, functions, or operations.

What is claimed is:

1. A storage apparatus comprising:
a disk array; and
an encryption/decryption processor interior to the disk array and adapted to perform data encryption and decryption operations on a per-logical unit basis.

2. The apparatus according to claim 1 further comprising:
a plurality of channel host adapters adapted to communicate data among multiple host systems;
at least one disk controller;
an array of storage disks coupled to the at least one disk controller; and
a duplexed cache coupled between the plurality of channel host adapters and the at least one disk controller, the encryption/decryption processor being coupled between the plurality of channel host adapters and the duplexed cache.

3. The apparatus according to claim 1 further comprising:
an interface adapted to optionally interconnect the encryption/decryption processor with an encryption/decryption assistance module.

4. The apparatus according to claim 1 further comprising:
an array of storage disks coupled to the encryption/decryption processor, the storage disks being logically accessed in logical units; and
a memory table shared among the array of storage disks and the logical units, the memory table being coupled to the encryption/decryption processor and adapted to track predetermined storage disks and logical units that store encrypted data.

5. The apparatus according to claim 4 further comprising:
a logic coupled to the encryption/decryption processor and the storage disk array that maps a requested logical unit to at least one storage disk, designates data location and destination, and maintains a list of logical units and disks that store encrypted data.

6. The apparatus according to claim 1 further comprising:
a logic coupled to the encryption/decryption processor and the storage disk array that generates a unique per-array encryption key.

7. A storage apparatus comprising:
an encryption/decryption processor configured for usage interior to a disk array and adapted to perform data encryption and decryption operations on a per-logical unit basis.

8. The apparatus according to claim 7 further comprising:
a first buffer adapted to couple to a plurality of channel host adapters and hold data passing to and from multiple host systems;
a second buffer adapted to couple to a duplexed cache and buffer data passing to and from the duplexed cache; and
an encryption/decryption engine coupled between the first buffer and the second buffer and adapted to encrypt and decrypt selected data.

9. The apparatus according to claim 8 further comprising:
a pass-through link coupled between the first buffer and the second buffer and adapted to pass data between the first and second buffers, bypassing the encryption/decryption engine.

10. The apparatus according to claim 9 further comprising:
a control logic coupled to the first buffer, the second buffer, the encryption/decryption engine, and the pass-through link, the control logic adapted to selectively enable and disable encryption/decryption engine activation and data bypass through the pass-through link.

11. The apparatus according to claim 10 further comprising:
an interface coupled to the control logic and adapted to optionally interconnect the encryption/decryption processor with an encryption/decryption assistance module.

12. The apparatus according to claim 10 further comprising:
a memory table coupled to the control logic and holding information shared among an array of storage disks and logical units associated with the storage disk array, the memory table being adapted to track predetermined storage disks and logical units that store encrypted data.

13. The apparatus according to claim 10 wherein:
the control logic generates a unique per-array encryption key.

14. A method comprising:
communicating data between at least one host system and a disk array;
selectively encrypting and decrypting the communicated data within the disk array on a per-logical unit/per-disk basis.

15. The method according to claim 14 further comprising:
receiving a host write from a host at the disk array that designates logical unit, track, sector, and length information;
selectively encrypting the write data for an encryption-enabled host write operation;
caching the encrypted write data for the encryption-enabled host write or unencrypted write data for an encryption-disabled host write;
selectively transferring the cached write data to a remote array cache for a remote-replication-enabled operation;
returning a write-complete message to the host;
mapping the requested logical unit to one or more designated disk controllers;
informing the one or more designated disk controllers of write data location and destination; and
writing the data to one or more designated disks.

16. The method according to claim 14 further comprising:
receiving a read request from a host at the disk array that designates logical unit, track, sector, and length information;
checking for a cache hit indicative that the read request data is cached;
if cache hit status is negative, reading data from one or more disks designated by the read request;
selectively decrypting the read data for encrypted read data or passing-through the read data without decrypting for unencrypted read data; and
transferring the requested read data to the host in combination with a read-complete indication.

17. The method according to claim 14 further comprising:
de-staging remotely-replicated encrypted or non-encrypted data comprising:
receiving remotely-replicated data;
parsing the remotely-replicated data to ensure completeness and ordering;
checking the remotely-replicated data according to a shared memory table used to track encrypted data stored in identified storage disks and logical units;
passing-through the remotely-replicated data without encryption based on previous encryption of encrypted data or non-encryption of non-encrypted data;
mapping a logical unit for the remotely-replicated data to storage; and
writing the remotely-replicated data to storage.

18. The method according to claim 14 further comprising:
reading remotely-replicated data comprising:
during suspension of a replicated pair, receiving from a local host a read request designating target information including at least logical unit, track, sector, and length information;
for a read request that is a cache hit, transferring requested data to the local host in combination with a read-complete signal; and
for a read request that is a cache miss, retrieving requested data from storage comprising:
reading the requested data from storage according to the designated target information;
caching the requested data;
checking a shared memory table that stores information indicative of whether the requested data is remotely replicated encrypted data or non-encrypted data;
for remotely replicated encrypted data, decrypting the requested data according to a decrypt key from the shared memory table;
for non-encrypted data, passing through the requested data without decryption; and
transferring requested data to the local host in combination with a read-complete signal.

19. An article of manufacture comprising:
a controller usable medium having a computable readable program code embodied therein for securing data stored in a disk array storage system, the computable readable program code further comprising:
a code adapted to cause the controller to communicate data between at least one host system and the disk array; and
a code adapted to cause the controller to selectively encrypt and decrypt the communicated data within the disk array on a per-logical unit/per-disk basis.

20. An article of manufacture according to claim 19 further comprising:
a code adapted to cause the controller to maintain within the disk array a shared memory table that tracks logical units and disks according to encryption and decryption status.

21. A storage apparatus comprising:
means for communicating data between at least one host system and a disk array;
means for encrypting and decrypting selected communicated data within the disk array on a per-logical unit/per-disk basis.

22. The apparatus according to claim 21 further comprising:
means for executing a host write at the disk array that designates logical unit, track, sector, and length information, the host write executing means further comprising:
means for encrypting selected write data for an encryption-enabled host write operation;
means for transferring selected cached write data to a remote array cache for a remote-replication-enabled operation;
means for returning a write-complete message to the host;
means for mapping the requested logical unit to one or more designated disk controllers;
means for informing the one or more designated disk controllers of write data location and destination; and
means for writing the data to one or more designated disks.

23. The apparatus according to claim 21 further comprising:
means for executing a read request from a host at the disk array that designates logical unit, track, sector, and length information, the host read request executing means further comprising:
means for reading requested data from a cache or, if uncached, from one or more disks designated by the read request;
means for selectively decrypting read data for encrypted read data or passing-through the read data without decrypting for unencrypted read data; and
means for transferring the requested read data to the host in combination with a read-complete indication.
